(19) United States
(12) Patent Application Publication
(10) Pub. No.: US 2019/0062564 A1
(43) Pub. Date: Feb. 28, 2019

(54) BASIC, HYDROPHOBIC FILLER, COATING COMPOSITION CONTAINING A FILLER OF THIS KIND

(71) Applicant: Gebrüder Dorfner GmbH & Co. KG Kaolin- und Kristallquarzsand-Werke KG, Hirschau (DE)

(72) Inventors: SUSANNE EIBERWEISER, Weiden (DE); REINHARD KRÄUTER, Sulzbach-Rosenberg (DE)

(21) Appl. No.: 16/111,632

(22) Filed: Aug. 24, 2018

(30) Foreign Application Priority Data
Aug. 24, 2017 (DE) 10 2017 119 361.8
Mar. 20, 2018 (DE) 10 2018 106 431.4

(51) Int. Cl. C09D 5/03; C09D 7/62; C08K 3/34; C08K 3/26; C08K 9/06

(52) U.S. Cl. CPC C09D 5/038; C09D 7/62; C08K 3/346; C08K 2201/005; C08K 9/06; C08K 2003/267; C08K 3/26

(57) ABSTRACT

The present invention relates to a filler, in particular a powdery filler, for a coating composition, in particular for a paint, a lacquer or an impregnating agent. The invention is characterised in that the filler comprises particles which have a surface coating, the particles comprising a siliceous or carbonatic component and having a basic pH value in aqueous solution, and the surface coating of the particles comprising one of the substances alkyltrimethoxysilane, alkyltriethoxysilane and/or alkyl siloxane. The invention furthermore relates to a coating composition containing a filler of this kind. In addition, the invention relates to uses of a filler of this kind for treating stones, ceramics or construction materials against moisture penetration, corrosion and algae, mold and/or plant growth.

This application claims priority to German Patent Application No. 10 2017 119 361.8, filed Aug. 24, 2017, and to German Patent Application No. 10 2018 106 431.4, filed Mar. 20, 2018, the disclosures of which are incorporated herein by reference.

### TECHNICAL FIELD

The present invention relates to a filler, in particular a powdery filler, for a coating composition, in particular for a paint, a lacquer or an impregnating agent. Furthermore, the invention relates to a coating composition containing a filler of this kind. The invention further relates to uses of a filler of this kind.

### BACKGROUND OF THE INVENTION

It is known from the prior art that high pH values prevent or slow the growth of algae and many plants. Water is also required for the growth of algae, mold and many plants, and therefore dryness also prevents or slows the growth of algae, mold and many plants. In regions having high humidity, or when water is present, corrosion is also promoted, and this can in addition be further accelerated by a low pH value.

However, materials having high pH values which could prevent or slow the growth of algae, mold and many plants, as well as corrosion, are not suitable for many applications owing to the other material properties thereof. An object of the present invention is therefore that of providing a filler which can be used in a composition for surface treatment (also referred to in the following as “coating composition” or “coating system”) and, after the composition is applied to a suitable material or a suitable body, results in less significant growth of mold, algae and/or plants on said material or said body and/or less corrosion of said material or said body.

### SUMMARY OF THE INVENTION

This object is achieved by a filler, in particular a powdery filler, for a coating composition, in particular for a paint, a lacquer or an impregnating agent. The invention is characterised in that the filler comprises particles which have a surface coating, the particles comprising a siliceous or carbonatic component and having a basic pH value in aqueous solution, and the surface coating of the particles comprising one of the substances alkyltrimethoxysilane, alkyltriethoxysilane and/or alkyl siloxane.

The term “filler” denotes a universally miscible substance that is preferably provided in the solid state of matter. The filler is preferably a powder or a pourable substance, similar to a sand. The filler contains the particles. In this context, said particles are also referred to as carrier particles. The surface coating of the particles denotes a coating of the particle surface. In this case, the particle surface may be covered with the surface coating completely or just in part. The surface coating is applied to the particles in a coating process.

According to at least one further embodiment, the surface coating comprises a hydrophobic component.

The hydrophobic component, also referred to as the active component, makes it possible for the filler, i.e. the particle comprising the surface coating, to be set so as to be more hydrophobic than the uncoated carrier particle. In this case, it is conceivable for the hydrophobic component to be the only component of the surface coating, or for the surface coating to comprise further components. It is furthermore conceivable for the surface coating to comprise a plurality of hydrophobic components. In this case, it is conceivable for the surface coating to comprise no further components, or one, or a plurality of further components in addition to the hydrophobic components.

According to at least one further embodiment, the particle consists of partially calcined dolomite, calcium silicate hydrate and/or kaolin.

In this case, particularly preferred particle materials, also referred to as carrier materials, are partially calcined dolomite, and calcium silicate hydrate. Kaolin is less preferred because, although this makes it possible to reduce the water absorption by means of a corresponding surface coating, the desired high pH value cannot be set (at least not permanently). Kaolin is not excluded, however.

When the surface coating is the same, the pH value of a 10% suspension of the above-mentioned fillers is dependent on the carrier particle material used. The pH values, measured depending on the carrier particle in each case, are:
carbonate compound: pH approx. 11.0 (±0.5),
silicate compound: pH approx. 10.5 (±0.5), and
kaolin: pH approx. 6 (±0.5).

Owing to the high pH values stated above for example compositions, these are sometimes subject to labelling. However, formulations for compositions for surface treatment are preferred that are not subject to labelling, since the pH value of the composition is below the critical value and does not contain any biocides that are subject to labelling.

According to at least one further embodiment, the alkyl group of at least one substance of the surface coating of the particles comprises at least one carbon chain having 6 to 12 carbon atoms, preferably between 7 and 10 carbon atoms, particularly preferably 8 carbon atoms.

The alkyl group is preferably part of at least one of the substances alkyltrimethoxysilane, alkyltriethoxysilane or alkyl siloxane. The properties, such as hydrophobic behaviour, of the surface coating can be set by means of the length of the carbon chain of the alkyl group. Owing to the number of carbon atoms in the at least one carbon chain being from 6 to 12, preferably between 7 and 10, particularly preferably 8 atoms, the substances alkyltrimethoxysilane, alkyltriethoxysilane and/or alkyl siloxane preferably have hydrophobic properties, and therefore, said substances constitute the active or hydrophobic component of the surface coating.

In this case, the at least one carbon chain may be linear or branched. If a plurality of carbon chains is present, both linear and branched chains may be included.

According to at least one further embodiment, the surface coating of the particle has ion-exchange properties.

The combination of the basic and hydrophobic properties of the filler has also been found to be advantageous because it remains active for a long time. The basic property of the filler or the high pH value is (by definition) noticeable only in the presence of water. However, the hydrophobic properties of the filler, set by the surface coating of the particles, displace water and/or accelerate re-drying after dampening. Without water, of course no, or only very reduced, growth of mold, algae or other plants, and very little or no corrosion, occur. When sufficient water is present for corrosion and/or possible growth of organisms, the pH value is so high in the phase in which water is present in the system that, despite the water, no growth and/or no corrosion can take place. Corrosion and/or growth of undesired organisms can thus preferably be excluded in all circumstances. Since the components that are contained in order to set the high pH value have to be active only at particular times, specifically in moist phases, the activity thereof can be maintained over a long period of time. It is preferably possible to reactivate the basic component during dry phases. This can preferably take place without human assistance. In order to ensure this, the active component preferably has ion-exchange properties.

According to at least one further embodiment, the particles have a diameter of between 0.01 μm and 5 mm, preferably in a range of from 0.02 μm to 2 mm, particularly preferably in a range of from 0.05 μm to 1 mm

The particle size of the carrier material or the carrier particles can be selected depending on the requirements in each case. However, it has been found that smaller carrier particles are advantageous owing to the more favourable surface to volume ratio thereof. In a preferred embodiment, the particle size of the carrier particles is in a range of from 0.01 μm to 5 mm, more preferably in a range of from 0.02 μm to 2 mm, particularly preferably in a range of from 0.05 μm to 1 mm Unless otherwise specified, in the following, particle sizes are to be understood as D₅₀ values in each case.

According to at least one further embodiment, the weight proportion of the surface coating of the particles is less than 10%, preferably between 0.5 and 8%, more preferably between 1 and 5% of the total weight of the filler.

Unless any specifications are made otherwise in connection with percentage specifications, within the meaning of this invention these denote weight percentages in each case.

According to at least one further embodiment, the filler is suspended in the coating composition, the weight proportion of the filler being between 5% and 80%, particularly preferably between 10 and 50%, very particularly preferably between 12 and 25% of the total weight of the coating composition.

In a preferred embodiment, the filler or a coating composition containing said filler is added to a coating substance or construction material that is selected from a group comprising plasters, dispersion paints, lacquers, cement, roof coatings, sealants and grouts.

The filler having hydrophobic and basic properties is preferably introduced into a coating system, as a result of which the pH value thereof is kept high. It has further been found that water absorption can be reduced and re-drying accelerated in materials coated with a coating system of this kind.

Since, in the construction industry, water damage, for example caused by moisture penetration, frost damage or mold and algae infestation, is associated with extremely laborious restoration, this advantageous property has been found to be advantageous in particular for materials used in the construction industry.

In a coating composition of this kind, it is particularly preferable for the surface of the filler to be available or accessible to growing organisms and/or water. It is also particularly preferable for a coating composition of this kind to be an open system, in particular a system open to (water) diffusion. Moreover, highly filled coating compositions have been found to be advantageous. The fillers according to the invention are therefore preferably part of in-can preserved systems and/or growth-inhibited systems that are not subject to labelling, since these systems preferably do not contain any biocides and particularly preferably have a pH value of below the critical value.

According to at least one further embodiment, the coating composition has a pH value of less than 11.5, preferably of between 5.5 and 11.5, particularly preferably of between 10.0 and 11.5.

Coating compositions having a pH value <11.5 are not subject to labelling according to H315, H318 or H355, pursuant to EC No. 1272/2008 paragraph 3.3.3.1.2. Since the filler according to the invention is in addition free of biocides, the coating composition having a pH value of <11.5 is not subject to labelling in this respect either. In this embodiment, in the case of particles in the filler that have a carbonatic component, the concentration of the particles in the coating composition should be set such that a pH value <11.5 is achieved.

However, coating compositions having a pH value of greater than or equal to 11.5 are not excluded from the invention. Although these coating compositions are subject to labelling with regard to the basic character thereof, such coating compositions according to the invention again do not contain any biocides, and therefore, they have an advantage over biocide-containing coating compositions since corrosion and/or growth of algae, mold or plants is likewise prevented or reduced, and in addition better environmental compatibility of the product is ensured.

It is known from the prior art that strongly basic fillers are extremely suitable for formulating corrosion-resistant lacquers. As the pH value increases, the corrosion of the metal surface slows. When the pH value is sufficiently high, the corrosion can be stopped (Pourbaix diagram). The metal surface is located in the region of the passivity and will therefore not be oxidised and thus not corroded. The pH value above which the metal surface is no longer oxidised depends both on the metal or the metal composition and on the potential of the solution, and therefore no generally valid values can be specified.

It can be seen from the chemical equations below that water plays a significant role for the cathodic reaction in the corrosion process. Moreover, water is often a cause of loss of adhesion between the coating and the metal surface, which in turn promotes the transport of corrosion-active substances. The amount of corrosion can therefore also be reduced by setting the coating system in such a way that it can absorb as little water as possible. This can be achieved by means of suitable non-swellable binders or by means of hydrophobic fillers. The reduced water absorption and accelerated re-drying when using the fillers described here means that less water is available on the metal surface for the corrosion reaction.

A distinction is generally made between chemical and electrochemical corrosion. In this case, the fillers according to the invention are suitable for slowing, delaying or even preventing electrochemical corrosion.

In each corrosion process, an anode reaction (oxidation of the metal surface, with the release of e⁻) and a cathode reaction (reduction of oxygen at pH>4 or hydrogen protons at pH<4) occur. In this case, the speed-determining step is usually the cathode reaction. If said reaction can be inhibited or prevented, this also applies to the anode reaction.

Anodic region Me→Me²⁺+2e⁻

Cathodic region H₂O+½O₂+2e→2OH

Consecutive reactions:

Me²⁺+2OH⁻→Me(OH)₂

2Me(OH)₂+½O₂+2H₂O→2Me(OH)₃

Me(OH)₃→MeOOH+H₂O

It has been found that a filler according to the invention can also be used as a corrosion-resistant (pigment). In this case, the filler preferably acts in a bi-functional manner, specifically both physically, in that the hydrophobia creates a water barrier or impedes water access, and chemically, in that the basicity of the filler slows or even prevents the chemical reactions set out above, in this case in particular the cathode reaction.

Coating compositions for corrosion resistance from the prior art generally contain a specific corrosion inhibitor in order to achieve the desired corrosion resistance. The filler according to the invention makes it possible to entirely dispense with using a corrosion inhibitor of this kind or to at least significantly reduce the concentration of said inhibitor.

According to at least one further embodiment, the coating composition further comprises a corrosion inhibitor, the corrosion inhibitor amounting to less than 3%, preferably less than 2%, particularly preferably less than 1%, and very particularly preferably less than 0.5% of the total weight of the coating composition.

The object according to the invention is furthermore addressed by the use of a filler that comprises particles having a surface coating, the particles comprising a siliceous or carbonatic component and having a basic pH value in aqueous solution, and the surface coating of the particles comprising one of the substances alkyltrimethoxysilane, alkyltriethoxysilane and/or alkyl siloxane, in a coating composition for treating stones, ceramics, metals or construction materials against moisture penetration, corrosion and algae, mold and/or plant growth.

Furthermore, the fillers according to the invention can be used for in-can preservation. A sufficiently high pH value in the system prevents the growth of undesired organisms during storage. This pH value can be set by means of the above-mentioned fillers comprising the particles contained therein. Since the fillers preferably have a depot effect at least with respect to the pH value, this high pH value can also be maintained over a very long period of time.

The fillers are preferably used for growth-prevention. As mentioned above, it is known that highly basic fillers can inhibit the growth of fungi and algae. This property can be further increased by the fillers according to the invention, since the presence of water is a basic requirement for the growth of fungi and algae, and, owing to the hydrophobia of the filler, water is present in the coated body only in a reduced amount. The hydrophobia of the filler can preferably reduce the water load of the coating both in terms of amount and also temporally. As a result, the organisms that may possibly grow are deprived of the water basis.

Moreover, the hydrophobia and the high pH value inhibits or prevents the above-described course of the corrosion process and the anodic and cathodic partial reactions thereof, with the result that coated materials can be protected from corrosion by means of the coating composition containing the filler.

Further advantages, aims and properties of the present invention will be explained with reference to the following description of the accompanying drawings.

### BRIEF DESCRIPTION OF THE DRAWINGS

FIG. 1 is a graph showing the water absorption coefficients against time, shown by temporally successive measurements.

### DETAILED DESCRIPTION OF THE INVENTION

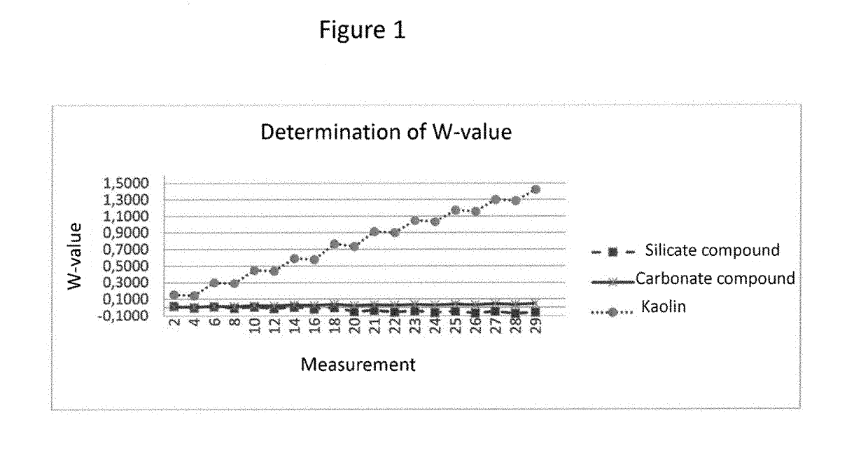

FIG. 1 illustrates the determination of the water absorption coefficient (w-value) for paving stones coated with a coating system that comprises 15% filler. The test is carried out in accordance with DIN EN 1062-3:2004. The paving stones were wetted for 6 hours, weighed, re-dried for 18 hours, and weighed again. Uncoated kaolin particles were used as a comparison material. As can be seen in FIG. 1, in the test conditions selected, the w-value of materials comprising a silicate compound, shown by the dashed line having square measuring point symbols, and a carbonate compound, shown by a solid line having crosses as measuring point symbols, remains close to the base line in each case. In contrast, for kaolin not coated with the coating system described, the w-value increases continuously, as shown in FIG. 1 by a dotted line having circles as measuring point symbols. Unlike in the case of the uncoated kaolin, the water absorption within the specified times can thus be reduced in the systems coated as described above.

In order to test the growth-inhibiting property of the filler, growth tests were carried out for the following organisms:
Aspergillus niger,
Staphylococcus aureus,
Bacillus Megaterium,
Chlorella vulgaris and
Pseudomonas aeruginosa.

It was possible to confirm the effectiveness for all these organisms. For this purpose, inter alia the tests set out in the following were carried out, which tests provided the results set out in each case.

a) Zone of Inhibition Test

The filler was tested when applied to agar that was subsequently inoculated. When tested on (Baird-Parker Agar) BP Agar, an inhibiting effect on the growth of Staphylococcus aureus was observed. When tested on (Luria Agar) L-Agar, it was possible to observe a growth-inhibiting effect on Bacillus Megaterium. It was also possible to inhibit the growth of Chlorella vulgaris on algal-agar.

b) Tests in Paint

In further tests, it was also possible to observe inhibition of the growth of Aspergillus niger and Pseudomonas aeruginosa (in addition to the organisms already mentioned above). In these tests, a paint for roof tile coatings was supplemented with 15% filler, mounted on filter paper, and the coated filter paper was laid on agar (coating on the side remote from the agar) and subsequently inoculated. The inhibition of the growth was even better when filler was worked into a binder. These tests furthermore showed that it is advantageous for the surface of the filler to be accessible, and that it is advantageous to use the filler in systems that are as highly filled as possible and/or in open systems.

c) Testing the Coating in Algal Suspension

In these tests, a paint for roof tile coatings was supplemented with 15% filler and mounted on filter paper. The coated filters were then placed in algal suspension and exposed to sunlight for 20 days at 28-30° C. The growth on the coatings was subsequently assessed. Using the strongly basic, hydrophobic filler made it possible to prevent growth.

d) Resistance of Exterior Paints to Mold Fungi and Algae

The resistance to algae was tested in a manner analogous with DIN EN 15458:2014. For this purpose, PVC test specimens were coated with paint to be tested and conditioned in a 23/50 climate. Sterilisation by means of gamma irradiation was subsequently carried out. The sterile test specimens are doused with a mixed algal suspension and incubated until significant algal growth has formed (approx. 2 weeks). The suspension is drained off, the growth on the test specimen surface assessed visually, and the batches are incubated for a further 2 weeks. The test specimens are then removed, assessed visually, and dried. A further assessment was carried out after cleaning using deionised water, by means of rinsing and drying.

It was possible to observe reduced growth of the tested organisms green algae (Stichococcus bacillaris) and blue algae (Gloeocapsa atrata), as well as easier cleaning of algal growth from the surface.

The effectiveness of a filler according to the invention in terms of the corrosion-resistance properties can be seen from the following example:

The hydrophobic, basic filler was subjected to a salt spray test, in accordance with EN ISO 9227, for 240 hours, in an amount of 16.40% in a formulation that in addition contains 0.8% inhibitor. The degree of blistering, evaluated in accordance with DIN EN ISO 4628-2, was 0 (S0).

In a comparison of conventionally used mica and hydrophobic, basic filler in formulation in an amount of 16.40% and omitting the use of inhibitors or corrosion-resistant pigment, the hydrophobic, basic filler performed better in this salt spray test.

The applicant reserves the right to claim all the features disclosed in the application documents as being essential to the invention, provided that said features are novel over the prior art, either individually or in combination. It is furthermore noted that the individual drawings also describe features that may be advantageous in their own right. A person skilled in the art will directly recognise that a specific feature described in a drawing may also be advantageous without adopting further features from this drawing. Furthermore, a person skilled in the art will recognise that advantages may also result from a combination of a plurality of features shown individually or in different drawings.

1. Filler, in particular powdery, for a coating composition, in particular for a paint, a lacquer or an impregnating agent, characterised in that the filler comprises particles which have a surface coating, the particles comprising a siliceous or carbonatic component and having a basic pH value in aqueous solution, and the surface coating of the particles comprising one of the substances alkyltrimethoxysilane, alkyltriethoxysilane and/or alkyl siloxane.

2. Filler according to claim 1, characterised in that the surface coating comprises a hydrophobic component.

3. Filler according to claim 1, characterised in that the particle consists of partially calcined dolomite, calcium silicate hydrate and/or kaolin.

4. Filler according to claim 1, characterised in that the alkyl group of at least one substance of the surface coating of the particles comprises at least one carbon chain having 6 to 12 carbon atoms, preferably between 7 and 10 carbon atoms, particularly preferably 8 carbon atoms.

5. Filler according to claim 1, characterised in that the surface coating of the particle has ion-exchange properties.

6. Filler according to claim 1, characterised in that the particles have a diameter of between 0.01 μm and 5 mm, preferably in a range of from 0.02 μm to 2 mm, particularly preferably in a range of from 0.05 μm to 1 mm

7. Filler according to claim 1, characterised in that the weight proportion of the surface coating of the particles is less than 10%, preferably between 0.5 and 8%, more preferably between 1 and 5% of the total weight of the filler.

8. Coating composition comprising a filler according to claim 1, characterised in that the filler is suspended in the coating composition, the weight proportion of the filler being between 5% and 80%, particularly preferably between 10 and 50%, very particularly preferably between 12 and 25% of the total weight of the coating composition.

9. Coating composition according to claim 8, characterised in that the coating composition has a pH value of less than 11.5, preferably of between 5.5 and 11.5, particularly preferably of between 10.0 and 11.5.

10. Coating composition according to claim 8, characterised in that the coating composition further comprises a corrosion inhibitor, the corrosion inhibitor amounting to less than 3%, preferably less than 2%, particularly preferably less than 1%, and very particularly preferably less than 0.5% of the total weight of the coating composition.

11. Use of a filler that comprises particles having a surface coating, the particles comprising a siliceous or carbonatic component and having a basic pH value in aqueous solution, and the surface coating of the particles comprising one of the substances alkyltrimethoxysilane, alkyltriethoxysilane and/or alkyl siloxane, in a coating composition for treating stones, ceramics, metals or construction materials against moisture penetration, corrosion and algae, mold and/or plant growth.
